(19) United States
(12) Patent Application Publication
(10) Pub. No.: US 2025/0327342 A1
(43) Pub. Date: Oct. 23, 2025

(54) INERTIAL DEVICE FOR A DOOR HANDLE AND SYSTEM COMPRISING SAID DEVICE

(71) Applicant: Minebea AccessSolutions Italia S.p.A., Pianezza (IT)

(72) Inventors: Marco SAVANT, Pianezza (IT); Alexandre PIERI, Pianezza (IT)

(73) Assignee: Minebea AccessSolutions Italia S.p.A., Pianezza (IT)

(21) Appl. No.: 19/185,964

(22) Filed: Apr. 22, 2025

(30) Foreign Application Priority Data
Apr. 22, 2024 (EP) 24171679.4

(51) Int. Cl. E05B 77/06

(52) U.S. Cl. CPC E05B 77/06

(57) ABSTRACT

A device configured to be mounted on a door handle of a motor vehicle includes a housing, a non-Newtonian fluid located within the housing, and a rotor at least partly immersed in the non-Newtonian fluid and intended to rotate about a rotor axis. The device forms a modular device configured to be connected to one end of a shaft of a door handle. A door handle assembly configured to be connected to the device is also provided.

### CROSS-REFERENCE TO RELATED APPLICATIONS

This application claims priority to and the benefit of EP 24171679.4, filed Apr. 22, 2024, the disclosure of which is incorporated herein by reference.

### FIELD

The present disclosure relates to the field of motor vehicle safety, in particular, it relates to a device intended to be mounted on a car door handle and to a system comprising said device.

### BACKGROUND

The statements in this section merely provide background information related to the present disclosure and may not constitute prior art.

The door handle on a vehicle is a critical safety feature, allowing occupants to escape in the event of an accident. However, the movable parts of the door handle mechanism can also be a hazard during a crash, as they can be subjected to significant acceleration and accidentally open the door.

To mitigate this risk, vehicle manufacturers are increasingly introducing mechanical inertial systems that can block the kinematic levers of the door handle mechanism before the door can open. These systems are designed to be sensitive to sudden changes in acceleration, and will engage automatically in the event of a crash.

While inertial systems are effective in preventing accidental door opening, they can also be complex and difficult to manage. This is because they must also be able to accommodate the normal acceleration of the vehicle during braking and cornering. The safety margin for these systems can also be narrow, meaning that they must be carefully calibrated to avoid false positives and negatives. This often implies to design a dedicated inertial system on purpose for each type of new handle.

Furthermore, in order to streamline the manufacturing process, these inertial systems need to be easy to manufacture without requiring extensive manufacturing operations or complex tools. In the event of a breakdown, these inertial systems must be changed simply and economically, and they must be suitable for installation on several types of door handles.

Some inertial systems are known in the state of the art like the one presented in EP0956411. However, the system from EP 0956411 is not easy to disassemble when mounted on a door handle and hence it cannot be changed simply and economically because it is mounted adjacent the interior surface of an escutcheon plate between the crank arms of the door handle.

### SUMMARY

This section provides a general summary of the disclosure and is not a comprehensive disclosure of its full scope or all of its features.

The aim of the present invention is to solve at least part of the above-mentioned drawbacks and to propose an inertial system concept as modular as possible which could be reused for different handle applications.

In particular, the invention aims at providing an inertial device intended to be mounted on a door handle assembly of a motor vehicle, as well as the door handle assembly itself, and a system comprising both the device and the assembly.

The invention relates to a device intended to be mounted on a door handle of a motor vehicle, comprising: a housing, a non-Newtonian fluid located within the housing, and a rotor at least partly immersed in the non-Newtonian fluid and intended to rotate about a rotor axis. The device forms a modular device configured to be connected to one end of a shaft of a door handle.

Advantageously, the device forming a modular device configured to be connected to one end of a shaft of a door handle allows to easily disassemble the device when mounted on a door handle.

Advantageously, the device can be detached from the shaft without using complex or expensive tools, and once detached from one shaft, the device can be connected to a different shaft. In other words, the device is adaptable and versatile and can be used with a variety of different shafts.

The device can also have one or more of the following features, taken alone or in combination.

The device may be configured such that when the rotor rotates past a threshold speed, the non-Newtonian fluid viscosity increases past a viscosity threshold.

When the non-Newtonian fluid viscosity increases past a viscosity threshold, the non-Newtonian fluid limits the rotation of the rotor. In other words, the non-Newtonian fluid opposes a resistance to the rotation of the rotor so that as to reduce its rotation speed, possibly until the rotor stops rotating.

The housing may be configured to connect to a unique end of the shaft via a means of connection, and preferably a single means of connection.

Advantageously, this housing configuration allows to disconnect the device and reconnect it to a different shaft.

The means of connection may be a single opening in the housing adapted to receive the one end of the shaft.

The single opening may have a polygonal shape, in particular a square shape.

The housing may comprise a compartment that is hermetically sealed.

Advantageously, this protects the internal components from moisture, dust, and corrosion and improves the device's durability.

The rotor may comprise at least one blade.

Advantageously, a rotor comprising a blade is simple to design and manufacture, and is lighter in weight.

The non-Newtonian fluid may be a rheopectic fluid.

The non-Newtonian fluid can potentially vary based on the application without changing the design of the rotor or the design of the housing.

The housing may have fixing holes intended to receive fixing means so as to fix the device to a door bracket.

Advantageously, fixing the device to the bracket allows a secure and rigid attachment.

The invention also relates to an assembly for a door handle of a motor vehicle, comprising: a shaft extending between two ends; a lever coupled to the shaft such that the rotation of the lever results in the concurrent rotation of the shaft; and a handle column connected to the lever and capable of being moved between a rest position and an extended position. The shaft has one end configured to be connected to a device according to what has been previously described.

The rest position of the handle column is the position in which the handle column is when it is not being used.

The extended position of the handle column is the position in which the handle column is extended from the door panel.

The assembly can also have one or more of the following features, taken alone or in combination.

The shaft may extend along a door panel, from an upper end to a lower end of the door panel.

Advantageously, this results in a compact design of the assembly.

The handle column may be configured to operate the lever between the two ends of the lever.

Advantageously, operating the lever between its two ends results in a symmetrical distribution of forces which reduces stress on the lever leading to increased durability and longevity.

The shaft may have one end configured to be connected to the device previously described and another end configured to rotate freely.

By configured to rotate freely, it is meant that the other end is not intended to be connected to any element.

The one end of the shaft that is configured to be connected to the device may comprise a flat intended to be inserted into the housing of the device.

Advantageously, the flat allows to connect the assembly to the device and to transmit the rotation of the shaft to the rotor and vice versa.

The assembly may further comprise a bracket configured to connect the handle column to a door panel.

The bracket helps to reinforce the door handle and make it more durable.

The assembly may further comprise a spring connected to the handle column and configured to resist the rotation of the shaft when the handle is pulled away from its rest position, and to assist the return of the handle column from the extended position to its rest position.

The spring provides resistance to the rotation of the shaft, which helps to prevent the door handle from being pulled too hard or too quickly. This is important to prevent damage to the door handle and the door latch mechanism.

Once the door is open, the spring helps to return the door handle column to its rest position. This is done by exerting a force in the opposite direction of the rotation of the shaft. This helps to ensure that the door handle is always in a ready position to close the door.

In addition to these two main purposes, the spring also helps to absorb some of the shock and vibration that is transmitted to the door handle when the door is opened and closed. This helps to extend the life of the door handle and the door latch mechanism.

The invention further relates to a system comprising: the device according to what has been described; and the assembly according to what has been described and that is configured to be connected to the device. The system is configured such that the device forms a modular device mounted to the assembly on one end of the shaft.

The device may be mounted to the assembly on one end of the shaft such that said one end of the shaft is inserted into the opening of the housing.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a partial sectional view of a first embodiment of an inertial device;

FIG. 2 is a perspective view of a second embodiment of the same inertial device;

FIG. 3 shows the inertial device according to the first embodiment mounted on a door handle assembly;

FIG. 4 is an exploded view of a system comprising the device according to the second embodiment and the door handle assembly; and

FIG. 5 is a lateral view of the interior of a door panel that shows a system comprising the inertial device according to the first embodiment.

The drawings described herein are for illustration purposes only and are not intended to limit the scope of the present disclosure in any way.

### DETAILED DESCRIPTION

In the following detailed description of the figures defined above, the same elements or elements performing identical functions may retain the same references in order to simplify the understanding of the invention.

The following description is merely exemplary in nature and is not intended to limit the present disclosure, application, or uses. It should be understood that throughout the drawings, corresponding reference numerals indicate like or corresponding parts and features.

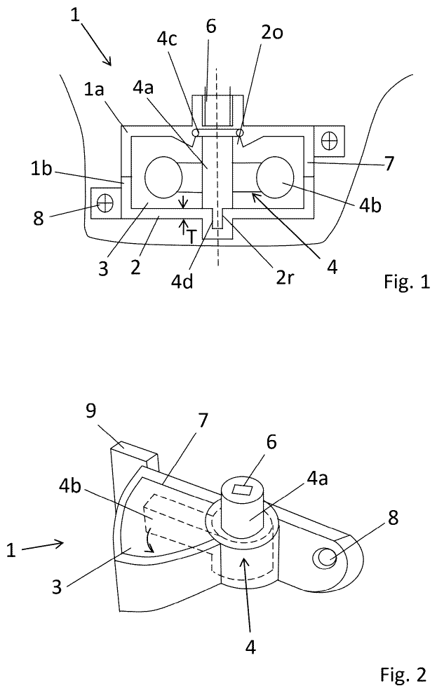

The invention relates to a device 1 intended to be mounted on a door handle of a motor vehicle such as a car for example. A first embodiment of this device 1 is presented in FIG. 1 and a second embodiment is presented in FIG. 2.

In both embodiments shown in FIG. 1 and FIG. 2, the device comprises a housing 2, a non-Newtonian fluid 3 located within the housing 2, and a rotor 4 at least partly immersed in the non-Newtonian fluid 3 and intended to rotate about a rotor axis X.

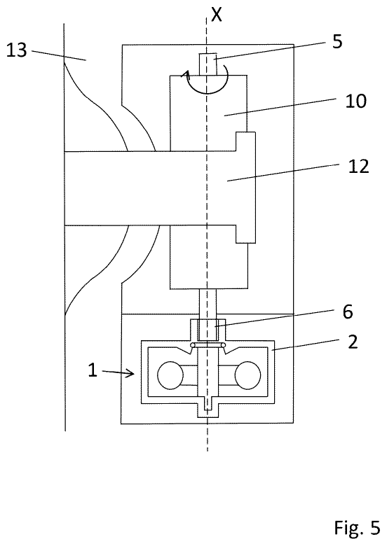

The rotor axis X is for example substantially parallel to the door panel as can be seen in FIG. 5.

The device is remarkable in that the device 1 forms a modular device

1 configured to be connected to one end of a shaft 5 of a door handle.

Advantageously, the device 1 is adaptable and versatile and can be mounted on a variety of different shafts 5. In other words, the device 1 is suitable for several types of door handles.

Advantageously, the device 1 can de detached from the shaft 5 without using complex or expensive tools and, once detached from the one end of the shaft 5, the device 1 can be connected to a different shaft 5.

The device 1 may be configured such that when the rotor 4 rotates past a threshold speed, the non-Newtonian fluid 3 viscosity increases past a viscosity threshold.

The fluids having this property to become more viscous when exposed to shear or stress are called “rheopectic fluids”. The choice of the rheopectic fluid can be fine-tuned based on the application or the acceleration range. For automotive applications, rheopectic fluids are well known in the field of lubrication and engine oils. There are different types of non-Newtonian oils available on the market which exhibit a rheopectic behavior.

The non-Newtonian fluid 3 may comprise oil, greases and similar products for lubrication applications.

For this type of oils, the non-Newtonian fluid apparent viscosity CCS is usually comprised between 2000 mPa·s and 10000 mPa·s depending on the temperature range.

The apparent viscosity increases rapidly with the shear rate. Experiments have shown that a shear rate comprised between 1 s⁻¹ and 2 s⁻¹ is enough to achieve the maximum peak of apparent viscosity.

During a crash, the handle lever will experience an angular acceleration and angular speed generating a shear on the non-Newtonian fluid by means of the rotor. During crashes between 30G up to 200G the angular speed of the lever is about few rad/s and can reach values up to about 45 rad/s depending on the balancing of the handle.

It is well known in the state of the art that the shear rate exerted on the non-Newtonian fluid is proportional to the angular speed of the rotor and can vary depending on the design of the rotor and housing (radius of the blade, height of the housing, etc.). Aspect ratio of the device can be calculated as the ratio between radius of the rotor and the height of the housing giving values of about 2 to 5 which is sufficient to achieve the apparent viscosity peak during a crash event.

Advantageously, when the non-Newtonian fluid 3 viscosity increases past a viscosity threshold, the non-Newtonian fluid 3 reduces the rotation speed of the rotor 4. In other words, the non-Newtonian fluid 3 opposes a resistance to the rotation of the rotor 4 so as to reduce its rotation speed, possibly until the rotor 4 stops rotating.

The housing 2 may be configured to connect to a unique end 5a of the shaft 5 via a means of connection 6, and preferably a single means of connection 6.

Advantageously, in such housing 2 configuration, the housing 2 and hence the device 1 can be connected to several different handles to choose from. Advantageously, this housing 2 configuration allows to disconnect the device 1 and reconnect it to a different shaft 5.

The means of connection 6 may be a single opening in the housing 2 adapted to receive the one end 5a of the shaft 5. Alternatively, the means of connection 6 may be an opening in the shaft 5 adapted to receive one end of the housing 2.

The single opening may have a polygonal shape, in particular a square shape as can be seen in FIG. 1 and FIG. 2.

Advantageously, the single opening can be easily arranged in the housing 2 and it allows to disconnect the device 1 and reconnect it to a different shaft 5.

The housing 2 may have a polygonal shape, in particular a rectangular shape as shown in FIG. 1 or a triangular shape as shown in FIG. 2. The rectangular shape is presented in FIG. 1 where a sectional view of the housing 2 is presented. A perspective view of the triangular shape of the housing 2 is presented in FIG. 2. The housing 2 may have a rectangular prism shape or alternatively a triangular prism shape.

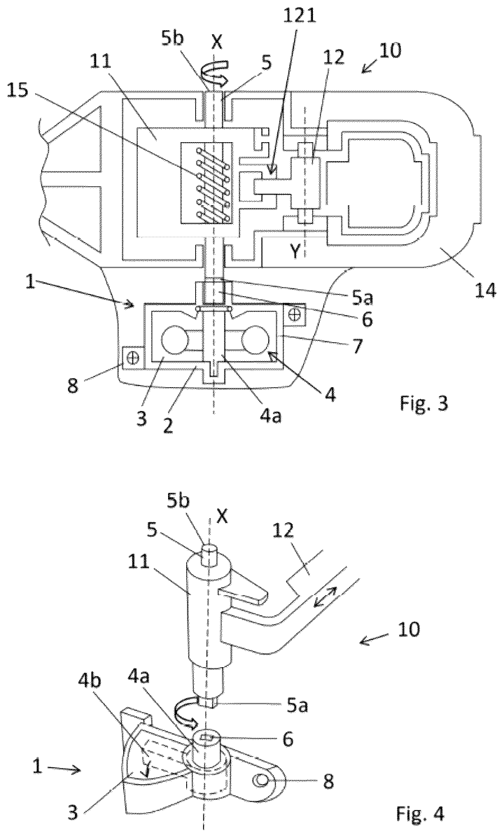

As can be seen in FIG. 1 and FIG. 3, the housing 2 may be made of two parts 1a, 1b, a first part 1a and a second part 1b, assembled together. The two parts 1a, 1b can be fixed together, for example, glued together and/or assembled by force together, and/or by means for fixing such as screws or by laser welding or ultrasonic welding. The first part 1a can include a front wall and/or a first lateral wall, the lateral wall extending for example from the front wall. The second part 1b can include a rear wall and/or a second lateral wall, the second lateral wall extending for example from the rear wall. The housing 2 is for example configured such that the first lateral wall and the second lateral wall are in contact when the first part 1a and the second part 1b are assembled together. The housing is for example configured such that the front wall and the rear wall are facing each other when the first part 1a and the second part 1b are assembled together. The first part 1a may present the means of connection 6. The second part 1b may present a recess 2r adapted to receive the projecting part 4d as described hereafter.

The front wall, for example, includes a front external face of the housing that is facing the shaft 5 when assembled. The rear wall for example includes a rear external face of the housing that is facing away from the shaft 5 when assembled. The first lateral wall and/or second lateral wall for example extend according to the direction defined by the rotation axis X.

When assembled to the door panel on the vehicle, the front wall is for example located higher than, for example on top of, the rear wall.

The housing 2 may comprise an opening 20 for example configured such that the cylindrical body of the hub 4a is able to pass through the opening 2o. In other words, the width of the opening 2o may be larger than the diameter of the cylindrical body of the hub 4a.

As can be seen in FIG. 1, the thickness T of the housing may be increased around the opening 2o. In particular, the thickness of the walls of part 1a that are in the area around the opening 2o may be increased. This increases the structural strength of the device 1.

The housing 2 may comprise a compartment 7, forming an inner space, which is hermetically sealed. The compartment 7 may be sealed using a seal. The seal may for instance be an O-ring gasket that may be placed on the hub 4a between the shaft 5 and the housing 2. The compartment 7 may be covered using a cover such as a laser welded cover placed on the top of the compartment 7.

The compartment 7 may have a pie slice shape.

The front wall, first lateral wall and/or second lateral, and rear wall may form the compartment.

Advantageously, the sealed compartment 7 protects the internal components from moisture, dust, and corrosion and improves the device's durability.

The housing 2 may have fixing parts, for example each having at least one fixing hole 8, the fixing parts and/or fixing holes being intended to receive fixing means so as to fix the device 1 to a door bracket 14. The fixing means can comprise screwing assemblies such as screws or screws with washers.

Advantageously, fixing the device 1 to the bracket 14 allows a secure and rigid attachment.

The device 1 may be configured such that each fixing hole 8 may receive a screw intended to fix the device 1 to the door bracket 14.

For example, the housing 2, for example, as shown in FIG. 1, can have at least two fixing parts, for example two fixing holes 8, for example a first fixing part and a second fixing part, for example a first fixing hole and a second fixing hole, for example the first fixing part having the first fixing hole and the second fixing part having the second fixing hole. For example, the first fixing hole is located on one side of the housing 2 and the second fixing hole is located on another side of the housing 2, such that the first fixing hole is offset from the second fixing hole, for example offset in the direction defined by the rotor axis X. It can be seen in FIG. 1, that the first fixing hole is at the top right side of the housing 2 whereas the second fixing hole is at the bottom left side of the housing 2. This helps to fix the housing 2 to the door handle while reducing the cost of fixing.

The first part 1a of the housing 2 may include the first fixing part and the second part 1b of the housing 2 may include the second fixing part.

By top, respectively bottom, it is for example meant an element that is relatively farther from, respectively closer to, the ground when assembled and in use on the vehicle.

By right, respectively left, it is for example meant an element that is to the right from, respectively to the left, when facing the door panel from the inside of the vehicle.

The housing 2 shown in FIG. 2 has only one fixing hole 8. This helps in obtaining a more compact device 1. Alternatively, the housing 2 can have several fixing holes 8, for example for enhanced fixation and/or easier fixation process. For example, the housing 2 can have two fixing holes 8.

The housing 2 may be made of one or several types of thermoplastic materials e.g. PP-GF40, PBT-PET GF30, PA6-GF50, etc.

Advantageously, the housing 2 is configured to be resistant to rust, corrosion, and impact damage.

The rotor 4 may comprise at least one blade 4b.

Advantageously, a rotor 4 comprising at least one blade 4b is simple to design and manufacture, and is lighter in weight.

The rotor 4 may comprise a hub 4a that is connected to the at least one blade 4b.

The hub 4a may be connected to the at least one blade 4b via a fixed joint.

Alternatively, the hub 4a and the at least one blade 4b may be formed in one piece.

The hub 4a may be connected to the shaft 5 as can be seen in FIG. 3 and FIG. 4 such that when the shaft 5 rotates, the hub 4a rotates as well and causes the at least one blade 4b to rotate.

The hub 4a may have an opening configured to receive the end 5a of the shaft 5. In this case, the opening of the hub 4a protrudes from the housing 2.

The hub 4a in FIG. 1 may comprise a cylindrical body that has an opening through which is inserted at least one blade 4b, for instance two blades or more than two blades. In the embodiment of FIG. 1, the blade 4b and the cylindrical body are connected via a fixed joint. The blade 4b and the cylindrical body can be the same part, for example if the design allows to manufacture the blade and the cylindrical body as one single part (e.g. if plastic injection molding or ZAMAK die casting is used to manufacture the blade and the cylindrical body), for example the blade 4b is integrally formed with the cylindrical body. The hub 4a also comprises a projecting part 4d that extends from the cylindrical body and that wedges the hub 4a into the housing 2. The projecting part 4d has a cylindrical shape. The housing 2 may present the recess 2r adapted to receive the projecting part 4d, the recess being for example shaped complementarily to the shape of the projecting part 4d.

The housing 2 has a thickness T defined by a space between an outer wall of the housing and an inner wall of the housing 2 which also corresponds to the wall of the sealed compartment 7.

Around the space where the projecting part 4d wedges the hub 4a into the housing 2, the thickness T of the housing may be increased with respect to the remaining space in the housing 2.

The housing 2, for example, the rear wall, may include a protrusion, for example extending from an external face of the housing, the protrusion corresponding to the recess 2r, the external face for example facing away from the hub 4a. That way it is possible to have the recess while limiting an excess thickness of the housing 2.

As can be seen in FIG. 1, a bearing 4c may be embedded in the housing 2, for example located within a dedicated recess of the housing 2, for example of the first part 1a, and part of the hub 4a may be inserted through the bearing 4c so that the hub 4a can rotate. The bearing 4c can be any of the following: a ball bearing, a roller bearing, a tapered roller bearing, a needle bearing.

In the embodiment presented in FIG. 1, the rotor 4 comprises at least one blade 4b, for instance two blades or more than two blades, that has a ball-shaped end and that is attached to the hub 4a via fixed joint or forms a single part with the hub 4a, and the hub 4a is connected to the one end of the shaft 5 so that, when the shaft 5 rotates, the hub 4a rotates as well and the blades rotate according to a circular rotation path within the housing 2. In other words, the blades may have a 360 degrees rotation around the axis X. The rotor 4 may comprise one blade and this advantageously yields a smaller more compact device 1.

The rotor may also comprise more than one blade, for instance two blades or more than two blades. This helps to increase the contact surface between the rotor 4 and the non-Newtonian fluid 3 and therefore to increase the breaking effect of the rotor 4 on the handle.

It is understood that all features relating to the at least one blade can apply if the rotor 4 comprises two or more blades.

In this configuration, the presence and the rotation of two blades increase the viscosity of the non-Newtonian fluid 3 at a faster pace and for a relatively large quantity of non-Newtonian fluid 3 within the housing 2, and therefore allows significant braking of movement during a car accident.

In the embodiment presented in FIG. 2, the rotor 4 comprises one blade that is attached to a hub 4a, the hub 4a being itself configured to be connected to one end 5a of the shaft 5 such that, when the shaft 5 rotates, the hub 4a rotates as well and causes the blade to rotate according to a trajectory which defines only an arc of a circle around the axis X.

Advantageously, the second embodiment is compact and can be easily mounted on a door handle assembly. In particular, the second embodiment is more compact than the first embodiment.

The hub 4a in the embodiment of FIG. 2 comprises a first cylindrical part inserted in a second cylindrical part that is connected to the blade 4b. The first cylindrical part has a flat on its surface. The flat aims to facilitate a connection with a given assembly.

The blades may be made of a thermoplastic material (polypropylene, Polyamide, etc.) or a metallic material such as steel or ZAMAK material for example.

The invention further relates to an assembly 10 for a door handle of the motor vehicle.

For each embodiment presented in FIG. 1 and FIG. 2, the corresponding assembly is presented in FIG. 3 and FIG. 4.

The assembly 10 comprises the shaft 5 extending between two ends 5a, 5b, from the lever 11. The rotation of the lever 11 results in the concurrent rotation of the shaft 5 (as they form one single element) and a handle column 12 that is connected to the lever 11 and capable of being moved between a rest position and an extended position. In other words, when the handle (or gripping element) is actuated, the lever 11 moves, which also moves the rotor 4. The handle column 12 is actuated by the handle, and this movement is transmitted to the lever 11. The handle column 12 can be a lever or part of the handle.

The handle column 12 may be part of the mobile part of the external door handle. While rotating about an axis parallel to the rotor axis X, the handle may pull on the lever 11 thanks to the handle column 12. The handle column 12 may be connected only to the bracket 14 but not to the door panel or the door itself.

The rest position of the handle column 12 is the position in which the handle column 12 is when it is not being used.

The extended position of the handle column 12 is the position in which the handle column 12 is extended from the door panel.

The lever 11 may comprise, for example in the first embodiment presented in FIG. 3, a main part that has a polyhedron shape. The lever 11 also comprises a connection part that protrudes from the main part and that connects the lever 11 to the handle column 12.

The shaft 5 and the lever 11 may be the same part.

The shaft 5 and the lever 11 may be components of a larger assembly that includes both the shaft 5 and the lever 11.

The assembly 10 is remarkable in that the shaft 5 has one end 5a configured to be connected to the device 1 as can be seen in both FIG. 3 and FIG. 4.

Advantageously, this assembly 10 allows to have the device 1 mounted on it and unmounted easily, i.e. without requiring complex tools. In other words, the connection between the assembly 10 and the device 1 is a removable connection, which means that the device 1 can be disconnected from the assembly 10 and reconnected to a different assembly 10.

The shaft 5 may extend along a door panel 13, from an upper end to a lower end of the door panel 13 as can be seen in FIG. 5.

Advantageously, this results in a compact design of the assembly 10.

The shaft 5 may have one end 5a configured to be connected to the device 1 and another end 5b configured to rotate freely. Which means that the device 1 can be easily disconnected from the assembly 10 because the device 1 is configured to be connected to the assembly only via one single end 5a.

By configured to rotate freely, it is meant that the other end is not intended to be connected to any element.

The one end 5a of the shaft 5 that is configured to be connected to the device 1 may comprise a flat intended to be inserted into the housing 2 of the device 1 as can be seen in FIG. 3 and FIG. 4.

The first embodiment shown in FIG. 3 shows a multipart connection between the lever 11 and the handle column 12. The connection between the lever 11 and the handle column 12 may be made of several distinct parts as can be seen in FIG. 3. In other words, the lever 11 and the handle column 12 may be two separate components that are connected to each other via a connecting part 121 and that have respective axis of rotation X and Y (shown in FIG. 3) that may be parallel to each other. Advantageously, the multipart connection between the lever 11 and the handle column 12 allows for the lever 11, the handle column 12 and the connecting part 121 to be easily assembled and disassembled.

As can be seen in FIG. 3, the flat is inserted in the opening 6 of the housing 2. This way, the flat allows to connect the assembly 10 to the device 1 and to transmit the rotation of the shaft 5 to the rotor 4 and vice versa.

The connection between the lever 11 and the handle column 12 may be a one-part connection as can be seen in FIG. 4. In other words, the handle column 12 and the lever 11 may be made as one single piece and have the same axis of rotation X. Advantageously, making the handle column 12 and the lever 11 as one single piece helps reducing the number of individual parts in the assembly 10, simplifies the assembly and reduces potential points of failures in the assembly 10.

FIG. 4 shows a one-part connection where the flat is aligned with the opening 6 in the hub 4a so that the one end 5a of the shaft 5 can be inserted in the opening 6.

The lever 11 in FIG. 4 comprises a main part that has a cylindrical shape and a connecting part that protrudes from the main part and that connects the lever 11 to the handle column 12. The one end 5a and the other end 5b both protrude from the main part.

The handle column 12 may be configured to operate the lever 11 between the two ends of the lever 11. The handle column 12 can operate the lever 11 by a simple mechanical contact. Grease may be added between the handle column 12 and the lever 11 to avoid any squeaking noise or mechanical wear during the assembly lifetime.

Advantageously, operating the lever 11 between its two ends results in a symmetrical distribution of forces which reduces stress on the lever 11 leading to increased durability and longevity.

The assembly 10 may comprise a spring 15 connected to the handle column 12 and configured to resist the rotation of the shaft 5 when the handle is pulled away from its rest position, and to assist the return of the handle column 12 from the extended position to its rest position. The spring 15 is shown in FIG. 3.

The spring 15 may be made of steel DIN 17223/C/D, for example with surface treatment to avoid corrosion of the spring.

The spring 15 provides resistance to the rotation of the shaft 5, which helps to prevent the door handle from being pulled too hard or too quickly. This is important to prevent damage to the door handle and the door latch mechanism.

Once the door is open, the spring 15 helps to return the door handle column 12 to its rest position. This is done by exerting a force in the opposite direction of the rotation of the shaft 5. This helps to ensure that the door handle is always in a ready position to close the door.

In addition to these two main purposes, the spring 15 also helps to absorb some of the shock and vibration that is transmitted to the door handle when the door is opened and closed. This helps to extend the life of the door handle and the door latch mechanism.

The assembly 10 may further comprise a bracket 14 configured to connect the handle column 12 to a door panel 13.

The bracket 14 helps to reinforce the door handle and to make it more durable.

The invention further relates to a system comprising the device 1, the assembly 10 that is configured to be connected to the device 1 wherein the system is configured such that the device 1 forms a modular device 1 mounted to the assembly 10 on one end of the shaft 5.

Advantageously, this kind of system can be easily disassembled, meaning that the device 1 can be easily removed from the system.

The device 1 may be mounted to the assembly 10 on one end 5a of the shaft 5 such that said one end 5a of the shaft 5 is inserted into the opening of the housing 2. Alternatively, the shaft 5 may comprise an opening and the device 1 may comprise a protruding connecting part that is aimed at being inserted in the opening of the shaft 5.

Such a system is presented in FIG. 5. FIG. 5 is a lateral view of a door panel that comprises the system comprising the device 1 (according to the first embodiment) connected to the assembly 10 via a connection between the shaft 5 and the opening 6 in the housing 2.

In FIG. 5, the handle column 12 is connected to the door handle and the system comprising the assembly 10 assembled to the device 1 extends along axis X in a direction substantially parallel to the door panel 13.

According to a particular example of the operation of the system, the system may operate as follows:

The door handle has movable parts (such as the handle column 12 and the lever 11) that are connected to the latch. These movable parts are needed to open the door.

The lever 11 may be directly connected to the latch by means of a rod or a bowden cable.

When the car is in an accident, the movable parts (especially the handle column 12 and the lever 11) are subjected to an acceleration and can accidentally open the door.

When the handle column 12 and lever 11 are being accelerated by the car accident, the acceleration is transmitted from the handle column 12 via the linkage to the lever 11, and from the lever 11 to the shaft 5 via the linkage between the lever 11 and the shaft 5.

The shaft 5 in its turn transmits the acceleration to the rotor 4 via the connection between the one end 5a of the shaft 5 and the device 1. The rotor 4 rotates with the same acceleration of the shaft 5.

The non-Newtonian fluid 3 viscosity increases as the rotor 4 rotation speed increases due to the shear generated on the non-Newtonian rheopectic fluid. The rotor 4 rotation speed may reach a threshold rotation speed at which the non-Newtonian fluid 3 viscosity reaches a viscosity threshold. At this viscosity threshold, the non-Newtonian fluid 3 becomes viscous enough and the non-Newtonian fluid 3 opposes a resistance to the rotation of the rotor 4 such that the rotor rotation speed starts to decrease. The rotor rotation speed may decrease until a complete stop of the rotation of the rotor 4, which leads to a stop in the rotation of the shaft 5 and therefore of the lever 11 and the handle column 12.

By complete stop of the rotation of the rotor 4, it is meant that the rotor 4 becomes immovable in relation to the reference of the door panel 13.

Hence, the accidental opening of the door is prevented in the event of a collision.

Although the invention has been described in relation to particular embodiments, it is clear that it is by no means limited thereto and that it includes all the technical equivalents of the means described, as well as combinations thereof, if these fall within the scope of the invention.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device configured to be mounted on a door handle of a motor vehicle, the device comprising:
a housing;
a non-Newtonian fluid located within the housing; and
a rotor at least partly immersed in the non-Newtonian fluid and configured to rotate about a rotor axis,
wherein the device forms a modular device configured to be connected to one end of a shaft of the door handle.

2. The device according to claim 1, wherein the device is configured such that when the rotor rotates past a threshold speed, a viscosity of the non-Newtonian fluid increases past a viscosity threshold.

3. The device according to claim 1, wherein the housing is configured to connect to a unique end of the shaft via a means of connection.

4. The device according to claim 3, wherein the means of connection is a single means of connection.

5. The device according to claim 3, wherein the means of connection is a single opening in the housing adapted to receive the one end of the shaft.

6. The device according to claim 1, wherein the housing comprises a compartment that is hermetically sealed.

7. The device according to claim 1, wherein the rotor comprises at least one blade.

8. The device according to claim 1, wherein the non-Newtonian fluid is a rheopectic fluid.

9. The device according to claim 1, wherein the housing has fixing holes configured to receive fixing means so as to fix the device to a door bracket.

10. An assembly for a door handle of a motor vehicle, comprising:
a shaft extending between two ends;
a lever coupled to the shaft such that a rotation of the lever results in a concurrent rotation of the shaft; and
a handle column connected to the lever and capable of being moved between a rest position and an extended position,
wherein the shaft has one end configured to be connected to the device according to claim 1.

11. The assembly according to claim 10, wherein the shaft extends along a door panel, from an upper end to a lower end of the door panel.

12. The assembly according to claim 10, wherein the handle column is configured to operate the lever between the two ends of the lever.

13. The assembly according to claim 10, wherein the shaft has one end configured to be connected to the device and another end configured to rotate freely.

14. The assembly according to claim 13, wherein the one end of the shaft that is configured to be connected to the device comprises a flat intended to be inserted into the housing of the device.

15. The assembly according to claim 10, further comprising a spring connected to the handle column and configured to resist the rotation of the shaft when the handle is pulled away from its rest position, and to assist return of the handle column from the extended position to its rest position.

16. A system comprising:
a device comprising a housing, a non-Newtonian fluid within the housing, and a rotor at least partly immersed in the non-Newtonian fluid and configured to rotate about a rotor axis, wherein the device forms a modular device configured to be connected to the one end of a shaft of the door handle; and
the assembly according to claim 10 and configured to be connected to the device,
wherein the system is configured such that the device forms a modular device mounted to the assembly on one end of the shaft.
